(19) United States
(12) Patent Application Publication
(10) Pub. No.: US 2005/0211275 A1
(43) Pub. Date: Sep. 29, 2005

(54) Surface-cleaning to remove metal and other contaminants using hydrogen

(76) Inventors: Yar-Ming Wang, Troy, MI (US); Hong-Hsiang (Harry) Kuo, Troy, MI (US); Devi N. Rai, Rochester Hills, MI (US); Kevin M. Cunningham, Washington, MI (US)

Correspondence Address: Kathryn A. Marra;General Motors Corporation, Mail Code 482-C23-B21, PO Box 300, Detroit, MI, 48265-3000, US

(21) Appl. No.: 10/810,983

(22) Filed: Mar. 26, 2004

(51) Int. Cl. B08B 5/00; C25B 1/04

(52) U.S. Cl. 134/37; 205/637; 205/766

(57) ABSTRACT

In one aspect, the invention provides a method of separating adhered matter from a surface of a conductive substrate comprising: producing gaseous hydrogen by electrolyzing water in contact with the surface of the substrate, dislodging the adhered matter by force of the evolved hydrogen; and transporting the dislodged matter from a vicinity of the surface.

### FIELD OF THE INVENTION

The present invention relates to preparation of conductive substrate surfaces for application of coating thereon.

### BACKGROUND OF THE INVENTION

In preparing coated substrates, application of a coating over imperfections on the surface to be coated essentially traps such imperfections in place. Conventional electrodeposition of surface films results in a film being formed that overlies surface imperfections, such as nodules or weld balls. Therefore, there is a need for an improved method to form coated surfaces to avoid such difficulties with imperfections.

### SUMMARY OF THE INVENTION

In one aspect, the invention provides a method of separating adhered matter from a surface of a conductive substrate comprising: producing gaseous hydrogen by electrolyzing water in contact with the surface of the substrate, dislodging the adhered matter by force of the evolved hydrogen; and transporting the dislodged matter from a vicinity of the surface.

In another aspect, the invention provides a method for applying coating onto a surface of a vehicle part that is electrically conductive, comprising: cleaning the surface with a solvent; immersing the part in an electrolyte solution while applying a potential of electric current between the surface of the part and a counter-electrode sufficient to generate hydrogen at the surface to electrochemically clean the surface; and then after electrochemically cleaning, applying a coating to the surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow chart showing the process according to the present invention.

FIG. 2 is a diagram of an apparatus according to the present invention.

### DETAILED DESCRIPTION OF THE PREFERRED EMBODIMENTS

The following description of the preferred embodiment(s) is merely exemplary in nature and is in no way intended to limit the invention, its application, or uses.

Weld balls and/or metal particles are produced and deposited on vehicle surfaces, interiors, and crevices during welding (i.e., spot welding, MIG welding, etc.) and grinding operations. The vehicle then undergoes cleaning with water or high-pressure water; phosphating; and coating electrodeposition, such as ELPO (Electrodeposited Polymer). The problem is that grease, dirt particles and weld balls attach to the ELPO layer. This results in a high dirt count in the painted finish. Attempts have been made to control metal contaminants through more washing, finer filtering, magnetic separation, and the like; however, the weld ball problem persists.

By the present invention, the source of the problem was determined and the improvement needed was also determined. After carefully examining the process flow, it was observed that although thorough washing and filtering somewhat reduced the weld ball content on the vehicle surfaces, when entering into the ELPO bath, the vehicle body still has many metal contaminants trapped on the surface and inside crevices at the surface.

During the ELPO process, some hydrogen gas agitates the surface; however, any agitated material at the surface remains deposited at the surface and, at the same time, a polymer film (the ELPO layer) is simultaneously forming on the vehicle surface under the film. This newly-formed film is an uncured, highly-entangled polymeric network that is analogous to sticky flypaper, trapping any particles at the vehicle surface. Thus, particles in the ELPO bath are trapped under the film as it is formed.

The present invention solves this problem by preventing or at least inhibiting weld balls and other dirt, grease, particulate, and adhered matter on the vehicle surface prior to the ELPO polymeric coating bath. In the method of the invention, a hydrogen-flushing effect, or hydrogen evolution, dislodges adherent matter and removes it in a stage before the coating stage.

Prior to the ELPO stage, the vehicle is subjected to a cathodic voltage sufficient to generate hydrogen gas in an apparatus designed to force particles from the surface and also move particles from the vehicle surface.

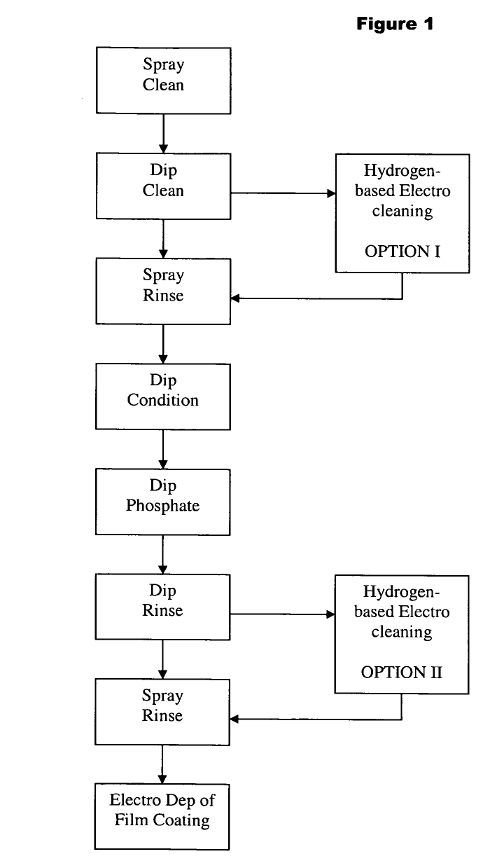

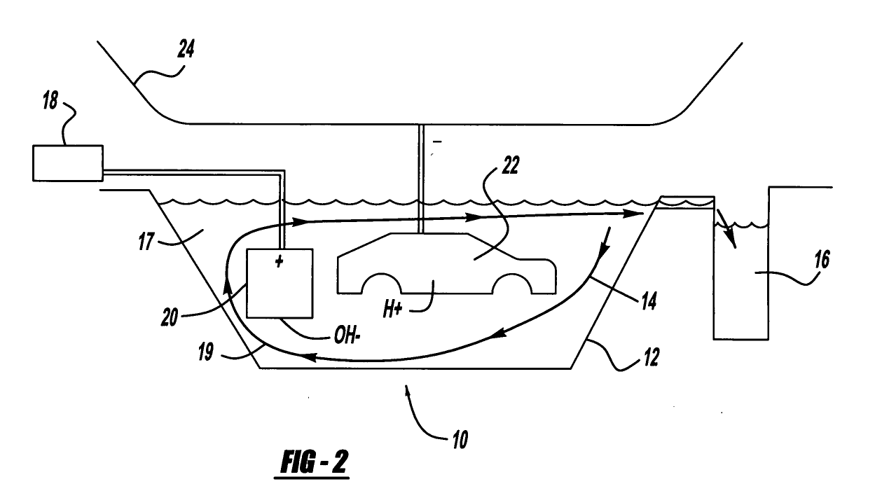

The process of the invention is shown in FIG. 1; and the apparatus is as shown in FIG. 2 which is a schematic of an electro-cleaning process exemplified by a vehicle substrate. The apparatus contains an electrolyte that is a non-aggressive acid or base, preferably a weak acid (i.e., weak phosphoric acid, or some borate salt solution, etc.). Conveniently, the process is carried out at room temperature. The electrochemical cleaning stage of the invention is introduced either before or after the phosphating stage. (See FIG. 1.) It is preferred that electrochemical cleaning occurs before phosphating to lower energy consumption. This is because a phosphated surface is not as good a conductor as the bare metal surface; and higher voltage will be needed to produce the same amount of hydrogen gas.

In the electrocleaning step of the invention, gaseous hydrogen is produced by electrolyzing water to dislodge adhered matter by force of the evolved hydrogen and, at the same time, dislodged matter is transported away by the moving electrolyte (see FIG. 2) in the vicinity of the surface to avoid re-deposition. Consequently, the metal and other contaminants will not attach to the bare metal surface. Thus, there is a significant reduction and near elimination of contaminants or weld balls in downstream film formation or painting processes.

This improvement is accomplished for the first time by subjecting the conductive substrate to an electrolysis cleaning, which is conducted while material dislodged from the substrate by such cleaning is transported away from the surface. The substrate, after having been subjected to electrolysis cleaning, is then advanced to the coating solution, where deposition of film-forming agents onto the surface of the substrate occurs virtually in the absence of adhered impurities at the surface because such impurities were dislodged and transported away from contact with the surface in the prior hydrogen-based electrocleaning, electrolysis stage.

This cleaning stage can be conducted prior the electrocoating (electrodeposition, ELPO), preferably at an immersion-cleaning tank. (See FIGS. 1 and 2.) The car body is the cathode, and stainless steel counter-electrodes are placed along the sides of the tank. The cleaning solution may be acidic or alkaline (pH 3 to 13).

FIG. 1 shows the overall steps of the process. The substrate, such as a vehicle part, is spray cleaned; dip cleaned; subject to electrocleaning, as per the invention Option I; then rinsed; conditioned with surfactant (optional); phosphated; rinsed once or twice by dip and/or spray; and then a coating is applied. In an alternate sequence, the substrate is spray cleaned; dip cleaned, spray rinsed; conditioned; phosphated; rinsed by dip, spray or both; then electrocleaned, as per invention Option II; then rinsed again; then a coating is applied.

FIG. 2 shows an apparatus 10 for electrocleaning comprising a tank 12 with eductor system 14, shown schematically, for moving fluid, along with a weir 16 for capturing particulate matter removed via electrolyte flow pattern 19. A DC power supply 18 supplies electric current to stainless steel counter-electrode anode 20 and substrate electrode cathode 22. Substrate cathode vehicle or vehicle part 22 moves along the conveyor system 24 through the electro-cleaning tank 12 which contains electrolyte 17.

It should be understood that the conventional pretreatment method of rinsing, alkaline bath cleaning, including phosphating, is not effective to remove the entrapped contaminants inside the crevices of vehicle bodies. The hydrogen gassing method, hydrogen evolution method of the invention is effective to flush out such micrometer sized particles. The function of apparatus 10 is exemplified by the following equations:

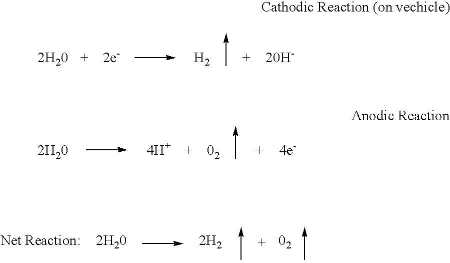

A preferred alkaline cleaning solution formula is shown below:
Sodium carbonate 20-30 g/l (NaCO₃)
Trisodium phosphate 20-30 g/l (Na₃(PO₄))
Surfactant 0.1-0.3 g/l (wets the surface, optional)
pH 9-13.

Other preferred operating conditions include:
Temperature: 50-70° C.
Voltage: 5-20 V
Duration: 10-90 seconds
Current density: 0.1-0.3 amps per square decimeter (A/dm²).
   An eductor system is used to provide proper flow pattern to sweep the solid particles to the surface of the solution and towards the exit (weir end). (See FIG. 2.) Note that the combination of agents is not aggressive to the galvanized substrate surface.

The present invention avoids difficulties with conventional electrodeposition coating processes, wherein a potential difference is applied between the substrate and the counter-electrode in an electrolyte in the presence of film-forming agents, whereby impurities and undesirable particulate matter present at the vehicle surface and in the deposition solution are entrapped along with film-forming agents at the surface of the electrical conductive substrate, thereby causing imperfections at the surface and under the film or coating. The method of the present invention essentially eliminates the occurrence of plating out of charged impurities from the solution onto the conductive surface.

The description of the invention is merely exemplary in nature and, thus, variations that do not depart from the gist of the invention are intended to be within the scope of the invention. Such variations are not to be regarded as a departure from the spirit and scope of the invention.

1. A method of separating adhered matter from a surface of a conductive substrate comprising:
producing gaseous hydrogen by electrolyzing water in contact with said surface of said substrate, dislodging said adhered matter by force of said evolved hydrogen; and
transporting said dislodged matter from a vicinity of said surface.

2. The method of claim 1, wherein said electrolyzing is conducted at a voltage greater than the electrolysis voltage of water.

3. The method of claim 1, wherein said dislodged matter is transported from a vicinity of said surface by flow of electrolyte via an eductor.

4. The method of claim 1, wherein said transporting of dislodged matter is conducted in the presence of a fluid that entrains said dislodged matter.

5. The method of claim 4, wherein said fluid comprises said water in contact with said surface of said substrate.

6. The method of claim 4, wherein said transporting comprises movement of at least one of said surface and said fluid relative to one another.

7. The method of claim 6, wherein said fluid moves.

8. The method of claim 6, wherein said substrate moves.

9. The method of claim 4, wherein said fluid has a density sufficient to entrain said dislodged matter.

10. The method of claim 1, wherein said conductive substrate constitutes a cathode.

11. The method of claim 2, wherein the voltage is at least 2 volts.

12. The method of claim 2, wherein voltage is at least 5 volts.

13. The method of claim 2, wherein the voltage is up to about 20 volts.

14. The method of claim 1, wherein the electrolyte medium comprises a basic electrolyte.

15. The method of claim 1, wherein the electrolyte medium comprises an acidic electrolyte.

16. The method of claim 1, wherein the electrolyte medium comprises sodium carbonate in an amount of about 20 to about 30 grams per litre of electrolyte medium.

17. The method of claim 1, wherein the pH of the electrolyte medium is in a range of about 3 to 13.

18. The method of claim 1, wherein the electrolyte medium comprises trisodium phosphate.

19. The method of claim 1, wherein said electrolyzing is at a current density of less than one amp per square decimeter (A/dm²).

20. The method of claim 19, wherein said current density is in a range of about 0.1 to about 0.3 A/dm².

21. A method for applying coating onto a surface of a vehicle part that is electrically conductive, comprising:
cleaning the surface with a solvent;
immersing the part in an electrolyte solution while applying a potential of electric current between the surface of the part and a counter-electrode sufficient to generate hydrogen at the surface; and then
removing the part from the electrolyte solution; and
applying a coating to the surface removed from the electrolyte.

22. The method of claim 21, wherein supply of electric current is initiated before the immersing.

23. The method of claim 21, wherein immersion occurs for a time period of up to about 2 minutes.

24. The method of claim 21, wherein immersion occurs for a time period of at least about 10 seconds.

25. The method of claim 21, wherein the potential of electric current continues to be supplied while the conductive substrate is being removed from the electrolyte medium.

26. The method of claim 21, wherein the removed substrate is rinsed before the coating is applied.

27. The method of claim 21, wherein said solvent comprises water or pressurized water.

28. The method of claim 21, wherein said coating is applied by immersing said vehicle part in a solution comprising a film-forming component, and applying a potential of electric current between said vehicle part and a counter-electrode.

29. The method of claim 21, further comprising baking the applied coating.
